(19) United States
(12) Patent Application Publication
(10) Pub. No.: US 2025/0217717 A1
(43) Pub. Date: Jul. 3, 2025

(54) System, Apparatus and Method for Machine-teaming Interactive Decisions (MIDS)

(71) Applicant: AtlasVision, Inc., New York, NY (US)

(72) Inventors: Richard Charles Arthur, Woodland Hills, CA (US); Brian Allen Evans, Arnold, MD (US)

(21) Appl. No.: 18/651,536

(22) Filed: Apr. 30, 2024

Related U.S. Application Data
(60) Provisional application No. 63/577,500, filed on May 1, 2023.

(51) Int. Cl. G06N 20/20

(52) U.S. Cl. CPC G06N 20/20

(57) ABSTRACT

A system, method and apparatus for synchronizing large data from multiple predetermined domains to facilitate critical time-sensitive decision-making, by receiving data from pre-defined sources, implementing an algorithm to predict outcomes associated with options, or subsets of options, at different times, and generating a decision tree based on the received data that is associated with options, the decision tree including branches associated with, respectively, subsets of the options. Generating the decision tree may include determining respective scores for at least one of the options or subgroups of options at the different times based on the predicted outcomes, rendering a subset of the branches of the decision tree having scores that satisfy a threshold value to a user, receiving user input which can revise the decision trees and re-generating decisions trees with updated predictions in response to user manipulation or updated source or factor data.

### REFERENCE TO RELATED APPLICATIONS

This application claims the benefit of U.S. Provisional Application No. 63/577,500, filed on May 1, 2023 the subject matter of which is hereby incorporated by reference.

### BACKGROUND OF THE INVENTION

In the face of an increasingly complex global landscape, with increased access to large data and increased computing power, a means is needed for human operators to quickly interpret, assess, and interact with large volumes of data-both general volumes and AI-generated volumes of data—from many sources in order to quickly make critical decisions (including, without limitation, military operations, cyber security, crisis operations, transportation operations, health decisions, etc.) based on those large volumes of changing data.

### FIELD OF THE INVENTION

This description pertains to multi-domain data-synchronization and manipulatable predictive decision tree generation and, more specifically, to a system, methods and apparatus for synchronizing large data from multiple predetermined domains to facilitate critical time-sensitive decision-making, by generating and rendering manipulatable predictive decision trees tied to predetermined factors, and which may re-generate and re-render decisions trees with updated predictions in response to user manipulation or updated source or factor data.

### BRIEF DESCRIPTION OF FIGURES

FIG. 1 is a block diagram of an example computing device according to an implementation.

FIG. 2 is an exemplary block diagram that illustrates a cloud-computing environment according to an implementation.

FIG. 3 is a block diagram of an example computing environment according to an implementation.

FIG. 4 is a view of the system architecture according to an implementation.

### DESCRIPTION OF THE INVENTION

This description pertains to a system, methods and apparatus for Machine-teaming Interactive Decisions (MIDS). MIDS provides a means for human operators to quickly interpret, assess, interact with, and make decisions based on large volumes of changing data from multiple sources and covering multiple domains. MIDS accomplishes this through symbiotic processing of decision trees, for example these could be AI-derived decision trees, and associated metadata which, for example, could be produced by a symbiote artificial intelligence (AI). The processing performed by MIDS generates manipulatable and updatable predictive decision trees (Digital Bonsai) that correspond both to source data and source factors. MIDS is capable of rendering these Digital Bonsai in any output or display format, including without limitation, two-dimension (2D) information displays and abstracted three-dimensional (3D) structures that may continuously update to enable human operators to intuitively analyze, evaluate and interact with data and processes to select optimized outcomes for implementation.

### DETAILED DESCRIPTION OF THE DRAWINGS

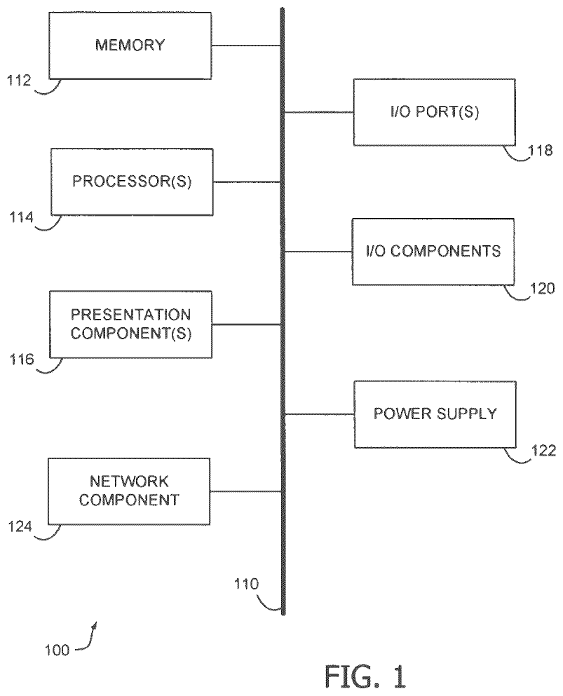

FIG. 1 is a block diagram of an example computing device 100 for implementing aspects disclosed herein, and is designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components/modules illustrated.

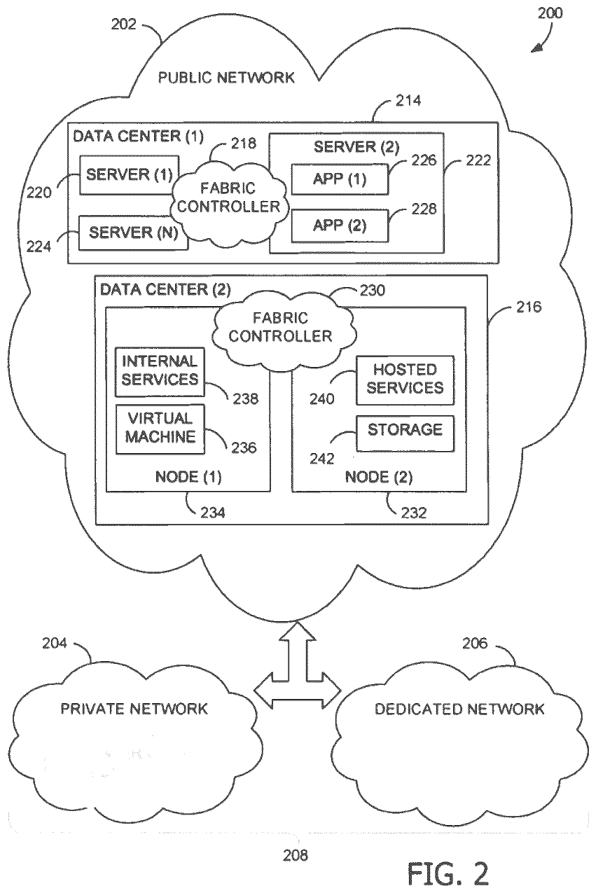

The examples and embodiments disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, devices not yet invented, etc. The disclosed examples may also be practiced in distributed computing environments, such as those disclosed in FIG. 2 described in more detail below, where tasks are performed by remote-processing devices that are linked through a communications network.

Computing device 100 includes a bus 110 that directly or indirectly couples the following devices: computer-storage memory 112, one or more processors 114, one or more presentation components 116, input/output (I/O) ports 118, I/O components 120, a power supply 122, and a network component 124. Computer device 100 should not be interpreted as having any dependency or requirement related to any single component or combination of components illustrated therein. While computer device 100 is depicted as a seemingly single device, multiple computing devices 100 may work together and share the depicted device resources. For instance, computer-storage memory 112 may be distributed across multiple devices, processor(s) 114 may provide housed on different devices, and so on. In addition, future inventions may provide a different path for implementing the disclosed invention.

Bus 110 represents what may be one or more busses (such as an address bus, data bus, or a combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. Such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” “augmented-reality device” etc., as all are contemplated within the scope of FIG. 1 as are categories and the references herein to a “computing device.”

Computer-storage memory 112 may take the form of the computer-storage media references below and operatively provide storage of computer-readable instructions, data structures, program modules and other data for the computing device 100. For example, computer-storage memory 112 may store an operating system, a universal application platform, or other program modules and program data. Computer-storage memory 112 may be used to store and access instructions configured to carry out the various operations disclosed herein.

As mentioned below, computer-storage memory 112 may include computer-storage media in the form of volatile and/or nonvolatile memory, removable or non-removable memory, data disks in virtual environments, or a combination thereof. And computer-storage memory 112 may include any quantity of memory associated with or accessible by the display device 100. The memory 112 may be internal to the display device 100 (as shown in FIG. 1), external to the display device 100 (not shown), or both (not shown). Examples of memory 112 in include, without limitation, random access memory (RAM); read only memory (ROM); electronically erasable programmable read only memory (EEPROM); flash memory or other memory technologies; CDROM, digital versatile disks (DVDs) or other optical or holographic media; magnetic cassettes, magnetic tape, magnetic disk storage or other magnetic storage devices; memory wired into an analog computing device; or any other medium for encoding desired information and for access by the display device 100. Additionally or alternatively, the computer-storage memory 112 may be distributed across multiple display devices 100, e.g., in a virtualized environment in which instruction processing is carried out on multiple devices 100. For the purposes of this disclosure, “computer storage media,” “computer-storage memory,” “memory,” and “memory devices” are synonymous terms for the computer-storage media 112.

Processor(s) 114 may include any quantity of processing units that read data from various entities, such as memory 112 or I/O components 120. Specifically, processor(s) 114 are programmed to execute computer-executable instructions for implementing aspects of the disclosure. The instructions may be performed by the processor, by multiple processors within the computing device 100, or by a processor external to the client computing device 100. In some examples, the processor(s) 114 are programmed to execute instructions such as those illustrated in the flowcharts discussed below and depicted in the accompanying drawings. Moreover, in some examples, the processor(s) 114 represent an implementation of analog techniques to perform the operations described herein. For example, the operations may be performed by an analog client computing device 100 and/or a digital client computing device 100.

Presentation component(s) 116 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 100, across a wired connection, or in other ways.

Ports 118 allow computing device 100 to be logically coupled to other devices including I/O components 120, some of which may be built in. Examples I/O components 120 include, for example but without limitation, keyboard, a microphone, joystick, game pad, satellite dish, scanner, printer, wireless device, motion sensor, haptic sensor etc.

The computing device 100 may operate in a networked environment via the network component 124 using logical connections to one or more remote computers, such as those shown in FIGS. 2 and 5. In some examples, the network component 124 includes a network interface card and/or computer-executable instructions (e.g., a driver) for operating the network interface card. Communication between the computing device 100 and other devices may occur using any protocol or mechanism over any wired or wireless connection. In some examples, the network component 124 is operable to communicate data over public, private, or hybrid (public and private) using a transfer protocol, between devices wirelessly using short range communication technologies (e.g., near-field communication (NFC), BLUETOOTH branded communications, or the like), or a combination thereof.

Turning now to FIG. 2, an exemplary block diagram illustrates a cloud-computing environment. Cloud environment 200 illustrates an exemplary cloud-computing infrastructure, suitable for use in implementing aspects of this disclosure. Cloud environment 200 should not be interpreted as having any dependency or requirement related to any single component or combination of components illustrated therein. In addition, any number of nodes, virtual machines, data centers, role instances, or combinations thereof may be employed to achieve the desired functionality within the scope of embodiments of the present disclosure.

The distributed computing environment of FIG. 2 includes a public network 202, a private network 204, and a dedicated network 206. Public network 202 may be a public cloud-based network of computing resources, for example. Private network 204 may be a private enterprise network or private cloud-based network of computing resources. And dedicated network 206 may be a third-party network or dedicated cloud-based network of computing resources. In some examples, private network 204 may host a customer data center, and dedicated network 206 may host cloud services 212.

Hybrid cloud 208 may include any combination of public network 202, private network 204, and dedicated network 206. For example, dedicated network 206 may be optional, with hybrid cloud 208 comprised of public network 202 and private network 204. Along these lines, some users may opt to only host a portion of their data center in the public network 202 and/or dedicated network 206, retaining some of the data or hosting of services in the private network 204. For example, a user that manages cyber security or military accounts may elect or be required to maintain various controls over the dissemination of data stored in its data center or the applications processing such data. Myriad other scenarios exist whereby users may desire or need to keep certain portions of data centers under their own management. Thus, in some examples, user data centers may use a hybrid cloud 208 in which some data storage and processing is performed in the public network 202 while other data storage and processing is performed in the dedicated network 206.

Public network 202 may include data centers configured to host and support operations, including tasks of a distributed application, according to the fabric controller 218. It will be understood and appreciated that data center 214 and data center 216 shown in FIG. 2 are merely examples of suitable implementations for accommodating one or more distributed applications, and are not intended to suggest any limitation as to the scope of use or functionality of examples disclosed herein. Neither should data center 214 and data center 216 be interpreted as having any dependency or requirement related to any single resource, combination of resources, combination of servers (e.g., servers 220 and 224) combination of nodes (e.g., nodes 232 and 234), or a set of application programming interfaces (APIs) to access the resources, servers, and/or nodes.

Data center 214 illustrates a data center comprising a plurality of servers, such as servers 220 and 224. A fabric controller 218 is responsible for automatically managing the servers 220 and 224 and distributing tasks and other resources within the data center 214. By way of example, the fabric controller 218 may rely on a service model (e.g., designed by a customer that owns the distributed application) to provide guidance on how, where, and when to configure server 222 and how, where, and when to place application 226 and application 228 thereon. One or more role instances of a distributed application, may be placed on one or more of the servers 220 and 224 of data center 214, where the one or more role instances may represent the portions of software, component programs, or instances of roles that participate in the distributed application. In other examples, one or more of the role instances may represent stored data that are accessible to the distributed application.

Data center 216 illustrates a data center comprising a plurality of nodes, such as node 232 and node 234. One or more virtual machines may run on nodes of data center 216, such as virtual machine 236 of node 234 for example. Although FIG. 2 depicts a single virtual node on a single node of data center 216, any number of virtual nodes may be implemented on any number of nodes of the data center in accordance with illustrative embodiments of the disclosure. Generally, virtual machine 236 is allocated to role instances of a distributed application, or service application, based on demands (e.g., amount of processing load) placed on the distributed application. As used herein, the phrase “virtual machine” is not meant to be limiting, and may refer to any software, application, operating system, or program that is executed by a processing unit to underlie the functionality of the role instances allocated thereto. Further, the virtual machine(s) 236 may include processing capacity, storage locations, and other assets within the data center 216 to properly support the allocated role instances.

In operation, the virtual machines are dynamically assigned resources on a first node and second node of the data center, and endpoints (e.g., the role instances) are dynamically placed on the virtual machines to satisfy the current processing load. In one instance, a fabric controller 230 is responsible for automatically managing the virtual machines running on the nodes of data center 216 and for placing the role instances and other resources (e.g., software components) within the data center 216. By way of example, the fabric controller 230 may rely on a service model (e.g., designed by a customer that owns the service application) to provide guidance on how, where, and when to configure the virtual machines, such as virtual machine 236, and how, where, and when to place the role instances thereon.

As discussed above, the virtual machines may be dynamically established and configured within one or more nodes of a data center. As illustrated herein, node 232 and node 234 may be any form of computing devices, such as, for example, a personal computer, a desktop computer, a laptop computer, a mobile device, a consumer electronic device, a server, the computing device 100 of FIG. 1, devices not yet invented that are capable of performing the invention and the like. In one instance, the nodes 232 and 234 host and support the operations of the virtual machine(s) 236, while simultaneously hosting other virtual machines carved out for supporting other tenants of the data center 216, such as internal services 238 and hosted services 240. Often, the role instances may include endpoints of distinct service applications owned by different customers.

Typically, each of the nodes include, or is linked to, some form of a computing unit (e.g., central processing unit, microprocessor, etc.) to support operations of the component(s) running thereon. As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the nodes to enable each device to perform a variety of processes and operations. In another instance, the computing unit may encompass a processor (not shown) coupled to the computer-readable medium (e.g., computer storage media and communication media) accommodated by each of the nodes.

The role of instances that reside on the nodes may be to support operation of service applications, and thus they may be interconnected via APIs. In one instance, one or more of these interconnections may be established via a network cloud, such as public network 202. The network cloud serves to interconnect resources, such as the role instances, which may be distributed across various physical hosts, such as nodes 232 and 234. In addition, the network cloud facilitates communication over channels connecting the role instances of the service applications running in the data center 216. By way of example, the network cloud may include, without limitation, one or more communication networks, such as local area networks (LANs) and/or wide area networks (WANs). Such communication networks are commonplace in offices, enterprise-wide computer networks, intranets, and the Internet, and therefore need not be discussed at length herein.

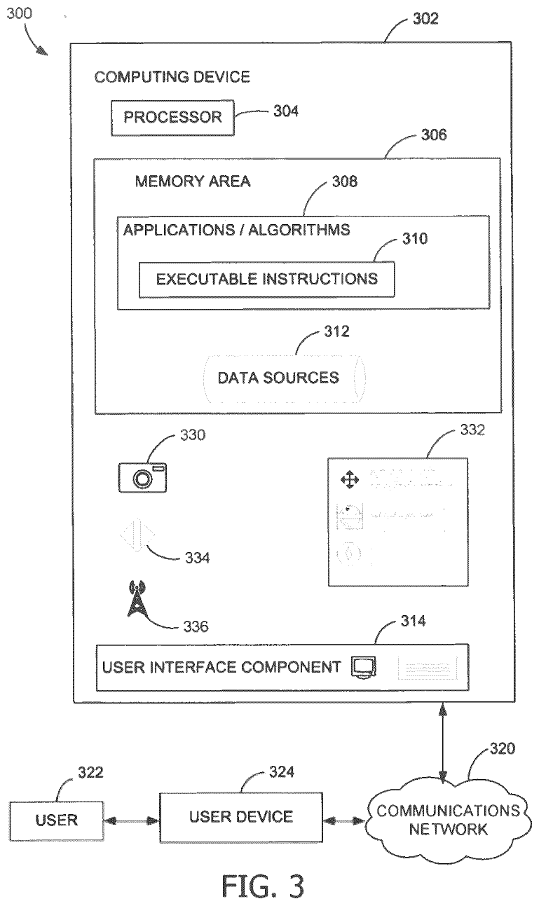

FIG. 3 is a block diagram of an example computing environment 300 that may be implemented as a real-world device using some of the various examples disclosed herein. Computing device 302 represents any device executing instructions (e.g., as application programs, operating system functionality, or both) to implement the operations and functionality as described herein. Computing device 302 may include a mobile computing device or any other portable device. In some examples, a mobile computing device includes a mobile telephone, laptop, tablet, computing pad, netbook, gaming device, wearable device, head mounted display (HMD) and/or portable media player. Computing device 302 may also represent less portable devices such as desktop personal computers, kiosks, tabletop devices, industrial control devices, wireless charging stations, electric automobile charging stations, and other physical objects embedded with computing resources and/or network connectivity capabilities. Additionally, computing device 302 may represent a group of processing units or other computing devices.

In some examples, computing device 302 has at least one processor 304, a memory area 306, and at least one user interface. These may be the same or similar to processor(s) 114 and memory 112 of FIG. 1, respectively. Processor 304 includes any quantity of processing units, and is programmed to execute computer-executable instructions for implementing aspects of the disclosure. The instructions may be performed by the processor or by multiple processors within the computing device, or performed by a processor external to the computing device. In some examples, processor 304 is programmed to execute instructions such as those that may be illustrated in the others figures.

In some examples, processor 304 represents an implementation of analog techniques to perform the operations described herein. For example, the operations may be performed by an analog computing device and/or a digital computing device.

Computing device 302 further has one or more computer readable media such as the memory area 306. Memory area 306 includes any quantity of media associated with or accessible by the computing device. Memory area 306 may be internal to computing device 302 (as shown in FIG. 3), external to the computing device (not shown), or both (not shown). In some examples, memory area 306 includes read-only memory and/or memory wired into an analog computing device.

Memory area 308 stores, among other data, one or more applications or algorithms 308 that include both data and executable instructions 310. The applications, when executed by the processor, operate to perform functionality on the computing device. The applications may communicate with counterpart applications or services such as web services accessible via a network, such as communications network 320. For example, the applications may represent downloaded client-side applications that correspond to server-side services executing in a cloud. In some examples, applications generated may be configured to communicate with data sources and other computing resources in a cloud during runtime, or may share and/or aggregate data between client-side services and cloud services. Memory area 306 may store data sources 312, which may represent data stored locally at memory area 306, data access points stored locally at memory area 306 and associated with data stored remote from computing device 302, or any combination of local and remote data.

The user interface component 314, may include instructions executed by processor 304 of computing device 302, and cause the processor 304 to perform operations, including to receive user selections during user interaction with universal application platform 308, for example. Portions of user interface component 314 may thus reside within memory area 306. In some examples, user interface component 314 includes a graphics card for displaying data to a user 322 and receiving data from user 322. User interface component 314 may also include computer-executable instructions (e.g., a driver) for operating the graphics card. Further, user interface component 214 may include a display (e.g., a touch screen display, a natural user interface, a 3D augmented reality display, etc.) and/or computer-executable instructions (e.g., a driver) for operating the display. In some examples the display may be a 3D display, such as may be found in an HMD or augmented reality device. User interface component 214 may also include one or more of the following to provide data to the user or receive data from the user: a keyboard (physical or touchscreen display), speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular way. In another example, the user may input commands or manipulate data by providing a gesture detectable by the user interface component, such as a touch or tap of a touch screen display or natural user interface. In still other examples, a user, such as user 322, may interact with a separate user device 324, which may control or be controlled by computing device 302 over communications network 320, a wireless connection, or a wired connection.

As illustrated, computing device 302 further includes a camera 330, which may represent a single camera, a stereo camera set, a set of differently-facing cameras, or another configuration. Computing device 302 may also further include an IMU 332 that may incorporate one or more of an accelerometer, a gyroscope, and/or a magnetometer. The accelerometer gyroscope, and/or a magnetometer may each output measurements in 3D. The combination of 3D position and 3D rotation may be referred to as six degrees-of-freedom (6DoF), and a combination of 3D accelerometer and 3D gyroscope data may permit 6DoF measurements. In general, linear accelerometer data may be the most accurate of the data from a typical IMU, whereas magnetometer data may be the least accurate.

Also illustrated, computing device 302 additionally includes a generic sensor 334 and a transceiver 336. In some embodiments, transceiver 336 is an antenna capable of transmitting and receiving radio frequency (“RF”) or other wireless signals over the network 106. One skilled in the art will appreciate and understand that various antennae and corresponding chipsets may be used to provide communicative capabilities between the display device 100 and other remote devices. Examples are not limited to RF signaling, however, as various other communication modalities may alternatively be used. The computing device 100 may communicate over a network. Examples of computer networks 106 include, without limitation, a wireless network, landline, cable line, fiber-optic line, local area network (LAN), wide area network (WAN), or the like, and such networks may comprise subsystems that transfer data between servers or computing devices 100. For example, the network 150 may also include a point-to-point connection, the Internet, an Ethernet, a backplane bus, an electrical bus, a neural network, or other internal system.

Generic sensor 334 may include an infrared (IR) sensor, a light detection and ranging (LIDAR) sensor, an RGB-D sensor, an ultrasonic sensor, or any other sensor, including sensors associated with position-finding and range-finding. Transceiver 336 may include BLUETOOTH, WiFi, cellular, or any other radio or wireless system. Transceiver 336 may act as a sensor by detecting signal strength, direction-of-arrival and location-related identification data in received signals. Together, one or more of camera 330, IMU 332, generic sensor 334, and transceiver 336 may collect data for use in algorithms.

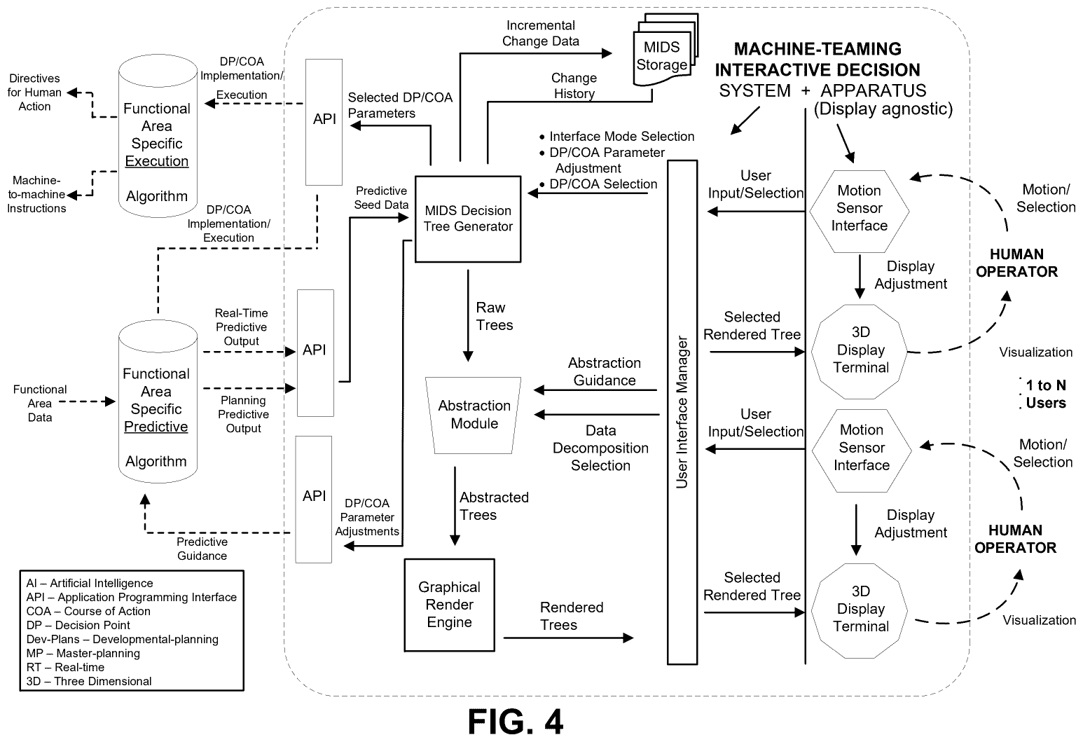

FIG. 4 is a view of the system architecture. There is a line at the edge of the system architecture to indicate that the system will render into any display. The diagram shows a 3D display purely as an example.

As described herein, a Machine-teaming Interactive Decision System (MIDS) addresses the challenge of an increasingly complex global landscape, with increased access to large data and increased computing power, and the need for human operators to quickly interpret, assess, and interact with large volumes of data-both general volumes and AI-generated volumes of data—from many sources in order to quickly make critical decisions (including, without limitation, military operations, cyber security, crisis operations, transportation management, health management, etc.). MIDS addresses this challenge through multi-domain data-synchronization and processing of large data volumes to facilitate critical time-sensitive decision-making, by generating and rendering manipulatable predictive decision trees tied to predetermined factors, and which may re-generate and re-render decisions trees with updated predictions in response to user manipulation or updated source or factor data. This enables human operators to intuitively analyze, evaluate and interact with data and processes to quickly assess and select optimized outcomes for implementation.

The form and function of MIDS is inspired by the relationship between the organic structure of a Bonsai tree and a human ‘Bonsai artist’. The underlying predictive algorithm provides the ‘data’ nutrients that enable MIDS to grow the ‘course of action’ branches that form the structure of the decision tree. A MIDS user harnesses the power of the underlying predictive algorithm by cultivating, pruning, or shaping (adjustment of decision point/course of action parameters) the various decision tree branches. This manner of interaction enables MIDS users to engage with and respond to large data sets and rapidly changing conditions that would normally exceed the limits of human cognition.

MIDS users may require differing time horizons for ‘tending’ a decision tree; therefore, MIDS supports both real-time and/or planning operations. While functionally similar, real-time operations facilitate decision-making for immediate implementation, as such, MIDS is capable of restricting the type and degree of adjustments to some parameters given the immediate time horizon. In contrast, planning operations support longer-term projection of outcomes with more flexibility in the type and degree of parameter adjustments. When users initiate planning operations, MIDS is capable of ‘spawning’ a new planning decision tree based on the current real-time decision tree. During planning operations, MIDS users may approve decision points/courses of action on a planning decision tree for implementation, which will reflect on the real-time decision tree and subsequently on all derived planning decision trees. Via real-time and planning modes of operation, MIDS users can interact with the decision tree on an appropriate timescale based on the demands of the functional area and environment.

MIDS also supports multi-user operation through user permissions and a decision hierarchy. Assignment of least-privilege user permissions restricts individual users' ability to adjust parameters (e.g., a user may only be permitted to adjust one type of resource allocation across all potential course of action), approve decision points/courses of action (e.g. a supervisor may be the only authorized user who can approved a planned course of action for real-time implementation), or operate MIDS functions (e.g. real-time versus planning operations) for which they are authorized. MIDS also implements a decision hierarchy schema that manages the priority and ability of individual users to approve, negate, modify, or override the parameter adjustments and decision point/course of action approvals for both real-time and planning mode operations. The implementation of user permissions and a decision hierarchy allows multiple users via individual interfaces to work collaboratively on the same decision tree, either real-time or planning, further amplifying the advantages of human-AI teaming.

To enable users to recall and reconstruct all parameter adjustments and decision point/course of action determinations, MIDS is also capable of actively storing all adjustments to real-time and planning decision trees driven by either the underlying predictive AI or user input. As a result, MIDS users can modify (if authorized) decision points/courses of action previously approved for future implementation, reconstruct the decision-making process for post-event analysis, or review/modify an active or completed planning decision tree. The storage of individual incremental change data enables the high-fidelity understanding of the decision-making process required dynamic highly complex operational environments.

MIDS is capable of being implemented as a symbiotic ecosystem, in which case it engages with a functional area specific predictive algorithm, which could include without limitation, a predictive AI (Functional Area Specific Predictive Algorithm), to provide the source input data for operation. As a result, the system characteristics and performance of the Functional Area Specific Predictive Algorithm, could directly influence MIDS operation.

The quality and availability of functional area data (e.g., historic, operational, environmental, system/sensor, etc.) processed by the Functional Area Specific Predictive Algorithm directly impacts algorithm/system output/performance. MIDS will operate with any data but MIDS output is improved by quality and availability of functional area data.

As depicted in FIG. 4, one aspect of the MIDS system is a System Input Application Programming Interface (API). The System Input API instantiation enables the ingestion of the Real-Time and/or Planning Predictive Output generated by the Functional Area Specific Predictive Algorithm, translating the data into the Predictive Seed Data for MIDS. System Input API is but one example of a suitable input environment and is not intended to suggest any limitation as to the scope of use or functionality of the invention. Neither should the System Input API be interpreted as having any dependency or requirement relating to any one or combination of components/modules illustrated.

As depicted in FIG. 4, another aspect of the MIDS system is MIDS Decision Tree Generator. The MIDS Decision Tree Generator processes the Predictive Seed Data based on, for example:
1) Predictive Limits-Predictive Limits are set by the Human Operator to bound the range of acceptable Decision Points/Courses of Action based on the level of confidence in Functional Area Specific Algorithm outputs under various inputs/conditions.
2) Decision Point (DP)/Course of Action (COA) Parameter Adjustments-DP/COA Parameter Adjustments provide Human Operator input on acceptable/desired levels of, for example, risk, implementation/execution time, and resource allocation for any branch within the decision tree.
3) DP/COA Selections-DP/COA Selections provide Human Operator input on next and/or future DPs/COAs for implementation/execution that could drive changes in operational, environmental, and or system conditions, thus altering the availability and/or effectiveness of various decision tree branches.

The processing performed by the MIDS Decision Tree Generator is capable of producing, for example and without limitation:
1) Raw Real-time Tree—Comprehensive decision tree graph encompassing possible decision tree DPs and resulting branches for a wide range of risk, implementation/execution time, and resources allocation within predictive limits.
2) Raw Planning Trees—Comprehensive decision tree graphs ‘spawned’ from the current Raw Real-time Tree. Similar to the Raw Real-time Tree, each individual Raw Planning Tree encompasses a range of possible decision tree DPs and resulting branches for a wide range of risk, implementation/execution time, and resources allocation within predictive limits. Additionally, changes in the Raw Planning Tree are reflected on all derived Raw Planning Trees.
3) Meta Data Tags—The subset of Predictive Seed Data concerning the possible factors, such as risk, implementation/execution time, and resource allocation requirements associated with each individual DP and branch for each generated Raw Tree.
4) Incremental Change Data—Record of individual changes or adjustments to either Raw Real-time or Raw Planning Trees resulting from Predictive Seed Data input or User adjustments.

While the Functional Area Specific Predictive Algorithm may or may not be capable of generating both Real-Time and Planning Predictive Outputs, MIDS supports both a Real-Time and Planning Mode Interface. This is accomplished through the MIDS Decision Tree Generator, which will produce both a singular Raw Real-time Tree and ‘spawn’ any number of Raw Planning Trees. The MIDS Decision Tree Generator is also capable of producing associated Meta Data Tags for each Raw Tree, regardless of whether it is the Real-Time or a ‘spawned’ Planning Tree. If the Functional Area Specific Predictive Algorithm is only capable of supporting one type of predictive output, either Real-Time or Planning, then the MIDS Decision Tree Generator will only maintain the respective Raw Tree(s) to facilitate processing efficiency.

As an element of Interface Mode Selection, based on assigned user permissions, Human Operators can choose to work in, for example, Real-Time or Planning Mode (Planning Mode can include historical analysis). Within each mode, again based on assigned user permissions, authorized Human Operators can adjust the Time Range associated with the respective Raw Tree and associated Meta Data Tags produced by the MIDS Decision Tree Generator. For each available Interface Mode supported by the Functional Area Specific Predictive Algorithm, initial and default Time Ranges can be set during system configuration.

Using the record of Incremental Change Data available within the MIDS Storage, the MIDS Decision Tree Generator enables Users to access the full Change History for the Raw Real-time or any Raw Planning tree, currently active or archived. Through the access to full Change Histories, Users can modify decision points/courses of action previously approved for future implementation, reconstruct the decision-making process for post-event analysis, or review/modify an active or completed planning decision tree.

Via System Output APIs, the MIDS Decision Tree Generator is capable of providing information, including without limitation, information regarding:
1) DP/COA Parameter Adjustments—In addition to informing processing of Predictive Seed Data, Human Operator inputs concerning DP/COA Parameter Adjustments can be forwarded to the Functional Area Specific Predictive Algorithm as predictive guidance to inform revised predictive outputs.
2) Selected DP/COA Parameters—In addition to informing processing of Predictive Seed Data, Human Operator inputs regarding DP/COA Selections can be further processed to aggregate the relevant original Predictive Seed Data concerning the risk, implementation/execution time, and resource allocation requirements associated with the specified selection. This aggregation of DP/COA Selection and relevant original Predictive Seed Data can be forwarded to the Functional Area Specific Predictive Algorithm to inform updated predictive outputs.
3) Selected DP/COA Parameters—In addition to the Functional Area Specific Predictive Algorithm, Selected DP/COA Parameters may be forwarded to the Functional Area Specific Execution Algorithm to inform instructions or actions that may be required or recommended for DP/COA Implementation/Execution.

The Raw Real-Time Tree and associated Meta Data Tags, as well as any active Raw Planning Trees and associated Meta Data Tags for each, may be forwarded by the MIDS Decision Tree Generator to the Abstraction Module for further processing.

As depicted in FIG. 4, another aspect of the MIDS system is MIDS Storage. MIDS Storage records the Incremental Change Data provided by the MIDS Decision Tree Generator. Additionally, MIDS Storage enables the MIDS Decision Tree Generator to recall at least a portion of the Change History for the Raw Real-time or any Raw Planning tree, currently active or archived. If desired, MIDS Storage could be augmented through additional storage capacity and/or data backup capabilities external to the MIDS architecture. The depicted MIDS Storage is but one example of a suitable storage environment and is not intended to suggest any limitation as to the scope of use or functionality of the invention. Neither should the MIDS Storage be interpreted as having any dependency or requirement relating to any one or combination of components/modules illustrated.

As depicted in FIG. 4, another aspect of the MIDS system is an Abstraction Module. The Abstraction Module is capable of processing the Raw Trees forwarded from the MIDS Decision Tree Generator to derive an Abstracted Tree. Abstraction Module processing applies characterization, classification, and generalization of DPs and branches to the individual Raw Trees. The resulting individual Abstracted Tree provides a representation of the associated Raw Tree that is intelligible at the level of human cognition. As a result, the Abstracted Trees provide the means through which human analysis, evaluation, and interaction with the comprehensive range of decision tree DPs and branches is possible. The depicted Abstracted Tree is but one example of a suitable implementation and is not intended to suggest any limitation as to the scope of use or functionality of the invention. Neither should the Abstracted Tree be interpreted as having any dependency or requirement relating to any one or combination of components/modules illustrated.

In this context and for purposes of example and illustration, Abstraction Guidance comprises the factors of variance and priority. Abstraction Variance defines the degrees of classification and generalization applied during processing necessary to achieve the desired level of intelligibility. Abstraction Priority defines the order that characterization and generalization processes are applied with respect to the individual data elements that comprise decision tree DPs and branches. Initial and default Abstraction Guidance can be provided during system configuration; however, based on assigned user permissions and hierarchy, Human Operators can provide revised Abstraction Guidance during MIDS operation.

Based on assigned user permissions, Human Operators may also provide Data Decomposition Selection input to the Abstraction Module. The Data Decomposition Selection input can inform the Abstraction Module regarding user(s) request for display of additional information on DP(s) or branch(s). Additional information, based on the specific user Data Decomposition Selection, can be added to the applicable Abstracted Tree and forwarded to the 3D Render Engine.

As depicted in FIG. 4, another aspect of the MIDS system is a Graphical Render Engine. The Graphical Render Engine uses the Abstracted Trees to generate the corresponding visual representations, including without limitation, 3D and 2D visual representation of the Abstracted Trees and additional information forwarded from the Abstraction Module. The Graphical Render Engine is capable of producing the requisite data concerning, for example, arrangement, orientation, scale, and color of DP and branch representations to maximize intelligibility. Additionally, to enable analysis and evaluation of similar branches, the Graphical Render Engine is capable of producing the data required for display of 2D Meta Data Tags and 3D visual decomposition of abstracted branches based on user Data Decomposition Selection. The resulting collective set of data, for example, for the Real-Time and all active Planning decision trees, would constitute the Rendered Trees. The Graphical Render Engine is capable of forwarding the Rendered Trees to the User Interface Manager for further processing. The depicted Graphical Render Engine is but one example of a suitable implementation and is not intended to suggest any limitation as to the scope of use or functionality of the invention. Neither should the Graphical Render Engine be interpreted as having any dependency or requirement relating to any one or combination of components/modules illustrated.

As depicted in FIG. 4, another aspect of the MIDS system is a User Interface Manager. The User Interface Manager is capable of parsing out each user's Selected Rendered Tree from the set of Rendered Trees forward by the Graphical Render Engine and forwarding the associated Selected Rendered Tree to the optional display terminal, including without limitation, a 3D Display Terminal or 2D display. The depicted User Interface Manager is but one example of a suitable implementation and is not intended to suggest any limitation as to the scope of use or functionality of the invention. Neither should the User Interface Manager be interpreted as having any dependency or requirement relating to any one or combination of components/modules illustrated.

In addition to providing an appropriate Selected Rendered Tree for display, the User Interface Manager processes User Input/Selection from all 1-to-N users. User Input/Selection comprises a number of different types of data. In all cases, the data is processed according to established user permissions and a decision hierarchy. Assignment of least-privilege user permissions enables the User Interface Manger to restrict individual users' ability to adjust parameters (e.g. a user may only be permitted to adjust one type of resource allocation across all potential course of action), approve decision points/courses of action (e.g., a supervisor may be the only authorized user who can approve a planned course of action for real-time implementation), or operate an authorized system function (e.g., real-time versus planning operations). The User Interface Manager is capable of implementing a decision hierarchy schema that employs a user's assigned priority to determine an individual user's ability to approve, negate, modify, or override the parameter adjustments and decision point/course of action approvals for both real-time and planning mode operations. As a result, the User Interface Manager may enable numerous individuals to work collaboratively on the same decision tree, either in real-time or in planning.

In certain examples, the User Interface Manager receives the following types of User Input/Selection data and processes it for forwarding to the MIDS Decision Tree Generator based on user permissions and hierarchy:
1) Interface Mode Selection-Human Operator selection for the MIDS Decision Tree Generator to switch between Real-Time and Planning Interface Modes or adjust the Time Scale of the currently selected Interface Mode as applicable.
2) DP/COA Parameter Adjustments-Human Operator adjustment to parameters associated with an individual DP or COA abstraction provided to the MIDS Decision Tree Generator to inform revised predictive outputs.
3) DP/COA Selection-Human Operator selection of a DP or COA provided to the MIDS Decision Tree Generator for implementation or as additional planning guidance, with either condition informing revised predictive outputs.

The User Interface Manager is capable of receiving input, including without limitation, the following types of User Input/Selection data and processing it for forwarding to, for example, the Abstraction Module based on user permissions and hierarchy:
1) Abstraction Guidance-Human Operator adjustment of Abstraction Variance and/or Priority provided to the Abstraction Module processes to inform the representative intelligibility of the process outputs.
2) Data Decomposition Selection-Human Operator selection provided to the Render Engine to display Meta Data Tags or visual decomposition of abstracted branches in order to provide additional information concerning the associated DP or branch.

For each available Interface Mode supported by the Functional Area Specific Predictive Algorithm, initial and default Time Ranges can be set during system configuration; and Human Operators can specify desired Time Ranges within the bounds of the Predictive Limits of the Functional Area Specific Predictive Algorithm system.

As depicted in FIG. 4, an optional aspect of the MIDS system can be a display terminal, including without limitation, a 3D Display Terminal(s) and a Motion Sensor Interface(s). The 3D Display Terminal for each user is capable of providing a 3D visualization of the Selected Rendered Tree as provided by the User Interface Manger per the selection of the specific Human Operator and their associated user permissions. The Motion Sensor Interface is capable of detecting Motion/Selection actions of the respective Human Operator in relation to the 3D visualization and translates this movement into instructions. The Motion Sensor Interface may forward all user instructions/inputs to the User Interface Manager, except for Display Adjustments-Human Operator direction to 3D Display Terminal to move/manipulate the Selected Rendered Tree in space exclusively in support of visualization. The functionality provided by the User Interface Manager enables MIDS to support any number (i.e., 1-to-N) 3D Display Terminals and Motion Sensor Interfaces required to support the desired user population. The depicted 3D Display Terminal and Motion Sensor Interface is but one example of a suitable implementation and is not intended to suggest any limitation as to the scope of use or functionality of the invention. Neither should the 3D Display Terminal and/or Motion Sensor Interface be interpreted as having any dependency or requirement relating to any one or combination of components/modules illustrated.

As depicted in FIG. 4, another aspect of the MIDS system is System Output APIs. In one example, a two System Output API instantiation is capable of enabling MIDS to forward data to external systems. The two System Output API could include, without limitation:
1) DP/COA Parameter Adjustment System Output API—The API is capable of receiving DP/COA Parameter Adjustment data from the MIDS Decision Tree Generator based on, for example, Human Operator input. The API translates the DP/COA Parameter Adjustment data into Predictive Guidance, which can be forwarded to the Functional Area Specific Predictive Algorithm to inform revised predictive outputs.
2) Selected DP/COA Parameters System Output API—The API is capable of receiving Selected DP/COA Parameters data from the MIDS Decision Tree Generator based on Human Operator input. The API is capable of translating the Selected DP/COA Parameters data into DP/COA Implementation/Execution data. The API can forward the DP/COA Implementation/Execution data, for example to: a. Functional Area Specific Predictive Algorithm-Data forwarded by the API can inform updated predictive outputs, and to b. Functional Area Specific Execution Algorithm-Data forwarded by the API can inform Machine-to-Machine Instructions or directives for Human Action which are suggested for DP/COA Implementation/Execution.
   The depicted System Output APIs are but one example of a suitable implementation and are not intended to suggest any limitation as to the scope of use or functionality of the invention. Neither should the System Output APIs be interpreted as having any dependency or requirement relating to any one or combination of components/modules illustrated.

The MIDS system has many use cases. For example, the MIDS may transform any system where critical decisions must be made quickly, and must consider data related to a range of factors for which data is often voluminous, changing quickly and not always timely available to the decision-maker. In addition, the available data often does not include the predictive downstream ramifications of selecting one path versus another. The following are three specific use case examples but there are any number of impactful applications across industries—in both potentially life-saving and more routine capacities. Any person who is responsible for rapidly making impactful decisions based on a multitude of factors will benefit from a MIDS implementation.

In Cybersecurity and by leveraging MIDS, cybersecurity practitioners could quickly assess the impact of network architecture changes, visualizing the potential ramifications of changes to individual or collective security policies. In the event of a network intrusion, operators could rapidly assess the effectiveness of response action in the prevention of further compromise, as well as the implications for network operations (e.g. distributions to network services, isolation of network segments, network connectivity latency, etc.). This understanding would facilitate a more holistic understanding of current and potential cybersecurity risk associated with change management under both deliberate and crisis situations.

In Mass Transit Operations Management and by leveraging MIDS, mass transit operators could quickly assess the impact of transit system distributions, visualizing the potential impacts to passenger flow and potential mitigation measures. Through MIDS visualization, central operators could team with station managers to effectively respond to unanticipated increases in passenger load (e.g. unidentified public event, higher than expected sporting event attendance, etc.) or disruptions (e.g. disabled train car, non-operable ticketing machines, etc.) by adjusting routing or frequency of services. The ability to rapidly compare and analyze multiple mitigation options simultaneously would facilitate more efficient decisions with respects to overall system operations.

In Military Operational Decision Making and by leveraging MIDS, military operators could quickly assess the potential outcomes of numerous potential courses of action, visualizing the effectiveness and resource requirements against identified measures. Through MIDS visualization, multiple specialists could provide subject matter expertise to generate improved responses rapidly and collaboratively in response to changing environmental factors and adversary actions. The simultaneously plan in a separate mode from real-world operations, enables input and innovation from all organizational levels with quality control provided by review/approval through an established decision hierarchy for assigned users. The ability to visualize and consider the full range of options, with an associated understanding of the resource requirements for each, would facilitate more effective unity of effort and economy of force in highly contested situations.

As used herein, a “Functional Area Specific Predictive Algorithm” may refer to a system/algorithm that generates decision trees based on projected decision points/courses of actions for application of designated resources within a defined operating environment (e.g., trucking logistics, cybersecurity, military force employment, etc.) and may refer to a system/algorithm that involves, for example, artificial intelligence, advanced computing, etc.

As used herein, “risk” may refer to the assessed possibility that a decision or course of action will fail to achieve a successful outcome as defined by the Human Operator within a Specific Functional Area.

Furthermore, it should be appreciated that numerous existing technologies, such as Microsoft HoloLens 2 or Oculus Rift, could be employed in a novel and new capacity to fulfill the functional requirements of the MIDS 3D Display Terminal, and that the present disclosure is not limited to these known technologies. Furthermore, it should be appreciated that numerous existing technologies, such as Optitrack or Polhemus VIPER, could be employed in a novel and new capacity to fulfill the functional requirements of the MIDS Motion Sensor Interface, and that the present disclosure is not limited to these known technologies.

Furthermore, it should be appreciated that MIDS does not require a Functional Area Specific Execution Algorithm to operate, but can support an interface if a Functional Area Specific Execution Algorithm is available. If a Functional Area Specific Execution Algorithm is not available, DP/COA Implementation/Execution data may be displayed for Human Action based on Human Operator interpretation.

### CROSS-REFERENCE TO RELATED APPLICATIONS

This application claims the benefit of U.S. Provisional Application No. 63/577,500, filed on May 1, 2023 the subject matter of which is hereby incorporated by reference.

1. A system comprising:
a non-transitory memory with executable instruction; and
a controller configured to implement the instructions to:
receive data from pre-defined sources,
implement an algorithm to predict outcomes associated with options, or subsets of the options, at different times, and
generate a decision tree based on the received data that is associated with options, the decision tree including branches associated with, respectively, subsets of the options, wherein the controller, when generating the decision tree:
determines respective scores for at least one of the options or subgroups of options at the different times based on the predicted outcomes, and
renders a subset of the branches of the decision tree having scores that satisfy a threshold value to a user.

2. The system of claim 1, wherein the controller, when rendering the decision tree, represents the decision tree to vary the scores along a first direction and to vary the times along a second direction.

3. The system of claim 1, wherein the controller renders the decision tree on a three-dimensional display device, and the controller, when rendering the decision tree, is further to visually separate the branches of the decision tree.

4. The system of claim 1, further comprising:
an input device configured to receive an input from the user,
wherein the controller adjusts scores for the options and/or branches based on the input from the user.

5. The system of claim 4, wherein the input identifies criteria to determine the scores based on predictive outcomes and uncertainties associated with the options.

6. The system of claim 4, wherein the input includes a selection of one of the branches of the decision tree, and the controller further presents information associated with the subset of the options for the selected one of the branches.

7. The system of claim 4, wherein
the input includes a selection of one of the branches of the decision tree, and
the controller generates a suggestion to improve the score for the selected one of the branches.

8. The system of claim 7,
wherein the controller, when generating the suggestion to improve the score, is further to:
identify possible modifications to data used by the algorithm when determining the score for the selected one of the branches,
determine one of the possible modifications to the data that would improve the score for the selected one of the branches, and
identify, as the suggestion, a change in the selected one of the branches corresponding to one of the possible modifications.

9. The system of claim 4, wherein the input device includes a sensor to detect a motion by the user to select one of the branches of the decision tree.

10. The system of claim 4, wherein the display is a three-dimensional display device, and the input device includes a sensor to detect a motion by the user to rotate the decision tree.

11. The system of claim 4, wherein the controller determines the threshold value based on the input.

12. The system of claim 1, further comprising:
an interface to exchange information with a computing device to implement at least one of an artificial-intelligence algorithm or an artificial-intelligence machine learning algorithm,
wherein the controller receives predictive seed data from the computing device, identifies parameters to be used by the computing device to predict outcomes associated with the different branches, and adjusts the parameters.

13. The system of claim 1, further comprising:
an input device configured to receive an input from the user,
wherein the controller determines possible outcomes for the options based on the input, and the algorithm determines a most likely one of the possible outcomes for each of the branches of the decision tree.

14. A method comprising
generating a decision tree associated with options, the decision tree including branches associated with, respectively, subsets of the options,
implementing an algorithm to predict outcomes associated with the options at different times,
determining respective scores for the options, or subgroups of options, at the different times based on the predicted outcomes, and
rendering a subset of the branches of the decision tree having ones of the scores that satisfy a threshold value.

15. The method of claim 14, wherein rendering the subset of the branches of the decision tree includes presenting the subset of the branches of the decision tree to vary the scores along a first direction and to vary the times along a second direction.

16. The method of claim 14, wherein rendering the subset of the branches of the decision tree includes presenting the subset of the branches of the decision in three-dimensions to visually separate the subset of the branches of the decision tree.

17. The method of claim 14, wherein the input identifies scores based on predictive outcomes and uncertainties associated with the options.

18. The method of claim 14, further comprising:
receiving an input selecting one of the branches of the decision tree, and
generating a suggestion to improve the score for the selected one of the branches.

19. An apparatus comprising:
a display; and
a computing device to:
generate a decision tree associated with options, the decision tree including branches associated with, respectively, subsets or combinations of the options,
predict outcomes associated with the options at different times,
determine respective scores for the options or subgroups of options, at the different times based on the predicted outcomes, and
control the display to render a subset of the branches of the decision tree having ones of the scores that satisfy a threshold value.

20. The apparatus of claim 19, further comprising:
an input device configured to receive an input from the user,
wherein the computing device determines possible outcomes for the options based on the input, and the display renders possible outcomes for each of the branches of the decision tree based on the input.
